(19) United States
(12) Patent Application Publication
(10) Pub. No.: US 2004/0262509 A1
(43) Pub. Date: Dec. 30, 2004

(54) Calibration of material analyzer and/or validation of said calibration with calibration/reference standard components

(76) Inventors: Chaur-Ming Shyu, San Diego, CA (US); William Edward Hood, El Cajon, CA (US); Steve Imperial Escobar, San Diego, CA (US); John Paul Axford, San Diego, CA (US); James Peter Stronski, San Diego, CA (US)

Correspondence Address: EDWARD W CALLAN, NO. 705 PMB 452, 3830 VALLEY CENTRE DRIVE, SAN DIEGO, CA, 92130, US

(21) Appl. No.: 10/608,797

(22) Filed: Jun. 27, 2003

(51) Int. Cl. G12B 13/00

(52) U.S. Cl. 250/252.1

(57) ABSTRACT

A set of calibration/reference standard components are used to calibrate and/or validate the calibration of a material analyzer of the type that has a measurement region and measurement apparatus for measuring properties of a material specimen occupying a given portion of the measurement region. The analyzer is calibrated or the calibration is validated by taking measurements while a calibration/reference standard of known chemical composition is disposed within the measurement region of the analyzer to simulate the occupancy of the given portion of the measurement region by the material specimen. The set includes elongated calibration/reference standard components that are individually packaged in a hard shell for being so combined with each other in the measurement region as to simulate the occupancy within the given portion of the measurement region by the material specimen, and are further individually packaged for unaided handling of individual components by one or two persons.

### BACKGROUND OF THE INVENTION

The present invention generally pertains to calibration and/or validation of the calibration of a material analyzer, and is particularly directed to the calibration/reference standard used for such calibration or validation.

Material analyzers are used to measure the elemental content of material specimens, such large quantities of chemicals, minerals, coal, cement, grains, etc., which usually are moving on a conveyor system or in pipeline. A material analyzer has a measurement region and measurement apparatus for measuring properties of a material specimen occupying a given portion of the measurement region. In one type of material analyzer, the material specimen is transported through the measurement region within a chute. This type of material analyzer is described in U.S. Pat. No. 4,582,992. In another type of material analyzer, the material specimen is transported through the measurement region on a conveyor belt. This type of material analyzer is described in U.S. Pat. No. 5,825,030. In these prior patents, the measurement region is referred to as an activation region.

It is necessary to frequently calibrate and validate the calibration of material analyzers by using calibration/reference standards of material whose chemical compositions are known and permanent. A known method of calibrating and/or validating the calibration of a material analyzer comprises the steps of:

(a) placing a calibration/reference standard of known chemical composition within the measurement region of the analyzer to simulate the occupancy of the given portion of the measurement region by the material specimen;

(b) making measurements with the measurement apparatus of the analyzer while the calibration/reference standard is within the measurement region; and

(c) calibrating or validating the calibration of the measurement apparatus in accordance with said measurements.

The chemical composition of a calibration standard, which is used for calibration, is more precisely defined throughout the standard than the chemical composition of a reference standard, which is used for validation.

U.S. Pat. No. 4,694,165 describes a calibration standard in the form of a calibration block of known chemical composition, which is dimensioned to be of almost the same cross-sectional size as the interior of a chute through which the material specimen is transported. The calibration block is inserted into the chute to simulate the occupancy by the material specimen of the given portion of the measurement region and which extends both above and below the measurement region when inserted in the chute. The calibration block is of such weight and dimensions that it cannot be placed in the measurement region without the aid of power-operated machines, such as a forklift or a crane. Similarly large calibration/reference standards are used for calibrating and validating the calibration of the type of material analyzer in which the material specimen is transported through the activation region on a conveyor belt. Since such a large type of calibration/reference standard is hard to manipulate, it is difficult to consistently position such a large standard in the measurement region so that the analyzer can measure the properties of the standard in a repeatable fashion. Also the large type of standard is susceptible to breakage, deterioration and segregation.

One known alternative to using such large calibration/reference standards is to stack a large number of relatively small blocks or bags of materials of known chemical composition within the measurement region to simulate the occupancy of the given portion of the measurement region by the material specimen. Although the blocks and bags are of such weight and dimensions that individual blocks and bags can be handled by one or two persons without the aid of power apparatus, it is difficult to consistently position the blocks or bags in the measurement region so that the analyzer can measure the properties of the standard in a repeatable fashion. Accordingly, it is a common practice to stack the blocks/bags outside of the measurement region and to then insert the stack into the measurement region by using power apparatus. Also the bags/blocks are difficult to store, more fragile and subject to loss, contamination and damage than the large type of calibration/reference standard, and require a large amount of time and effort to position and remove.

### SUMMARY OF THE INVENTION

The present invention provides a method of calibrating and/or validating the calibration of a material analyzer having a measurement region and measurement apparatus for measuring properties of a material specimen occupying a given portion of the measurement region while the material specimen is transported through the measurement region in a given direction, comprising the steps of:

(a) placing a calibration/reference standard of known chemical composition within the measurement region of the analyzer to simulate the occupancy of the given portion of the measurement region by the material specimen;

(b) making measurements with the measurement apparatus of the analyzer while the calibration/reference standard is within the measurement region; and

(c) calibrating or validating the calibration of the measurement apparatus in accordance with said measurements;

wherein step (a) comprises the step of:

(d) positioning within the measurement region a set of elongated calibration/reference standard components that are individually packaged in a hard shell for being so combined with each other as to simulate the occupancy within the given portion of the measurement region by the material specimen, and are further individually packaged for unaided handling of individual said components by one or two persons, with the individually packaged components being positioned within the measurement region so that their respective longitudinal axes are approximately aligned with the direction in which the material specimen is transported through the measurement region.

The present invention further provides a calibration/reference standard component of known chemical composition for use in calibrating and/or validating the calibration of a material analyzer of the type that has a measurement region and measurement apparatus for measuring properties of a material specimen occupying a given portion of the measurement region, and which is calibrated or the calibration is validated by taking measurements while a calibration/reference standard of known chemical composition is disposed within the measurement region of the analyzer to simulate the occupancy of the given portion of the measurement region by the material specimen, wherein the component is packaged in an elongated hard shell for being so combined with another said component in said measurement region as to simulate the occupancy within the given portion of the measurement region of the material specimen; and wherein the component is packaged for unaided handling by one or two persons.

The present invention further provides a set of calibration/reference standard components for use in calibrating and/or validating the calibration of a material analyzer of the type that has a measurement region and measurement apparatus for measuring properties of a material specimen occupying a given portion of the measurement region, and which is calibrated or the calibration is validated by taking measurements while a calibration/reference standard of known chemical composition is disposed within the measurement region of the analyzer to simulate the occupancy of the given portion of the measurement region by the material specimen, the set comprising: elongated calibration/reference standard components that are individually packaged in a hard shell for being so combined with each other in said measurement region as to simulate the occupancy within the given portion of the measurement region of the material specimen, and are further individually packaged for unaided handling of individual said components by one or two persons.

Additional features of the present invention are described with reference to the detailed description of the preferred embodiments.

### BRIEF DESCRIPTION OF THE DRAWING

FIG. 1 is a perspective view of an exemplary embodiment of a, prior art material analyzer of the type in which a conveyor belt transports a material specimen through a measurement region of the material analyzer.

FIG. 2 is a diagram of a portion of the prior art material analyzer of FIG. 1 adjacent the measurement region, as viewed in the direction of the conveyor belt.

FIG. 3 is a plan view of a preferred embodiment of an individually packaged calibration/reference standard component according to the present invention.

FIG. 4 is a sectional view of the individually packaged calibration/reference standard component of FIG. 3 taken along line 4-4 in FIG. 3.

FIG. 5 is a perspective view of a set of individually packaged calibration/reference standard components of the embodiment shown in FIGS. 3 and 4 disposed within the measurement region of the material analyzer of FIG. 1.

FIG. 6 is a diagram illustrating one example of a set of the individually packaged calibration/reference standard components of the embodiment shown in FIGS. 3 and 4 disposed within the measurement region of the material analyzer of FIG. 1, as viewed in the direction of the conveyor belt.

FIG. 7 is a diagram illustrating another example of a set of the individually packaged calibration/reference standard components of the embodiment shown in FIGS. 3 and 4 disposed within the measurement region of the material analyzer of FIG. 1, as viewed in the direction of the conveyor belt.

### DETAILED DESCRIPTION

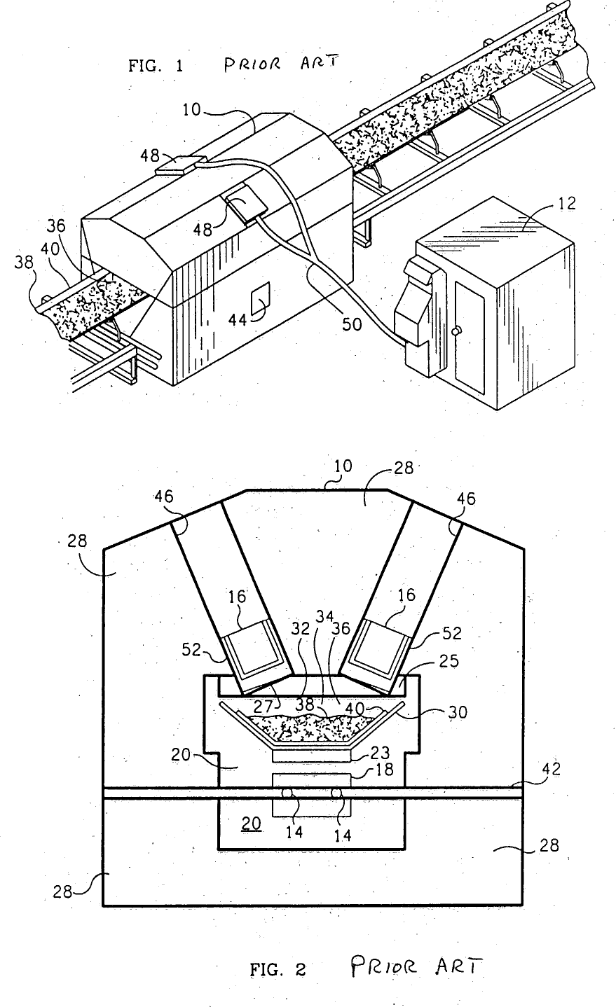

Referring to FIGS. 1 and 2, an exemplary embodiment of one type of prior art material analyzer includes a container 10, a data processor (not shown) within a separate housing 12, a pair of neutron sources 14, a pair of gamma-ray detectors 16, a gamma-ray shield 18, a neutron moderator 20, a neutron absorber 23, a neutron reflector 25 and radiation shielding material 28. The container 10 has interior surfaces 30, 32 defining a measurement region 34 between the neutron sources 14 and the gamma-ray detectors 16. A lower portion of the passageway-defining surfaces 30, 32 defines a trough 30 having upwardly extended sides adjacent the measurement region 34. The container surfaces 30, 32 further define a passageway 36 for enabling material specimens 38 to be transported through the measurement region 34 on a conveyor belt 40.

The neutron sources 14 are disposed within the container 10 beneath the passageway 36 on one (the lower) side of the measurement region 34 for emitting neutrons for bombarding a material specimen 38 being transported on a conveyor belt 40 through the measurement region 34 to cause gamma-rays to be emitted from the bombarded material specimen 38. The neutron sources 14 are inserted through a tubular neutron source cavity 42 in the container 10 into selected positions beneath the passageway 36, and are separated laterally on opposite sides of the longitudinal axis of the passageway 36. The neutron sources 16 are inserted into the neutron source cavity 42 through a door 44 in the container 10.

The gamma-ray detectors 16 are disposed within the container 10 above the passageway 36 on another (the upper) side of the measurement region 34 opposite from the one side for detecting gamma-rays emitted from the bombarded material specimen 38. The gamma-ray detectors 16 are inserted through detector cavities 46 in the container 10 into selected positions above the passageway 36. The gamma-ray detectors 16 are inserted into the detector cavities 46 through hatches 48 in the container 10. Signals produced by the gamma-ray detectors 16 are provided by electrical cables 50 to the data processor within the housing 12. The data processor processes these signals to analyze the transported material specimen 38.

This exemplary embodiment of such a material analyzer is further described in the aforementioned U.S. Pat. No. 5,825,030.

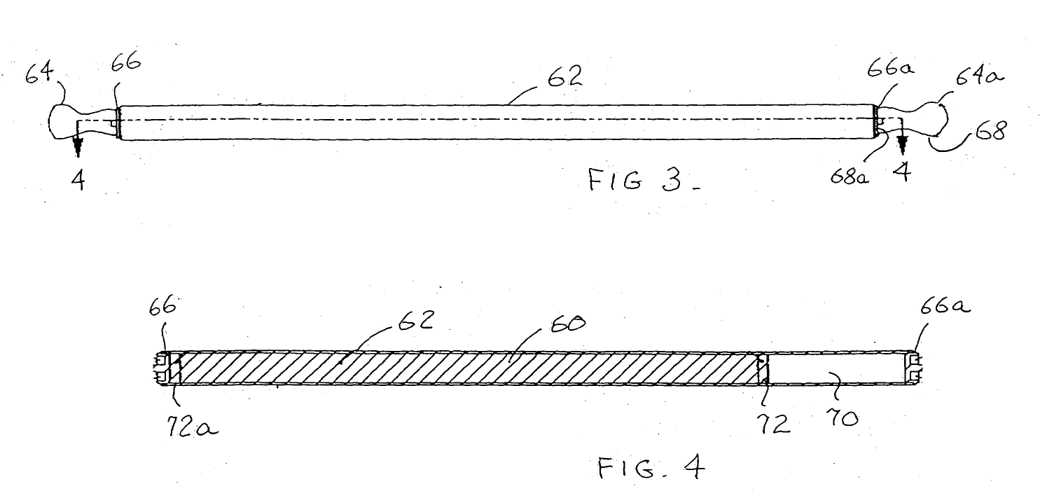

Referring to FIGS. 3 and 4, a preferred embodiment of an individual component 60 of a calibration/reference standard according to the present invention is packaged in an elongated hard shell 62 for being so combined with other such packaged component 60 in the measurement region 34 of a material analyzer as to simulate the occupancy within the given portion of the measurement region 34 of the material specimen 38. In the preferred embodiment the hard shell 62 is made of ABS plastic or another material having the same chemical elements as ABS plastic and properties of strength, durability and rigidity similar to those of ABS plastic.

The packaging includes straps 64, 64a attached to at least one end of the shell 62. The straps 64 can be gripped for handling the shell 62. The straps are made of Nylon or another material having properties of strength, durability and flexibility similar to those of Nylon. The straps 64, 64a are attached to end caps 66, 66a, which seal the respective ends of the shell 62. In an alternative embodiment (not shown), handles, rather than the straps 64, 64a are attached to the end caps 66, 66a for use in handling the shell 62. In one embodiment, such handles are made of a strong, durable and soft, plastic material.

An exterior location on the packaging displays a color code 68, 68a indicating the chemical composition of the calibration/reference standard component 60 contained within the shell 62. Such location is a common location on all of the packages of a given set of components 60. Preferably, one end of the packaging displays the color code 68, 68a. In an alternative embodiment, both ends of the packaging display the color code. In the preferred embodiment, the strap 64a attached to one end of the shell 62 includes a color code 68 indicating one aspect of the calibration/reference standard component 60; and the end cap 66a attached to the strap 64a at the same end of the shell 62 includes a color code 68a indicating another aspect of the calibration/reference standard component 60.

Table 1 below lists exemplary color codes for display on the strap 64 and end cap 66 of calibration/reference standard component packages for raw mix standard materials 106 through 110 and stockpile standard materials 116 through 120.

TABLE 1

| | | |
|---|---|---|
| Standard Material | End Cap | Strap |

RAW MIX STANDARDS

| | | |
|---|---|---|
| 106 | ORANGE | WHITE with RED FLECK |
| 107 | ORANGE | RED with WHITE TRACER |
| 108 | ORANGE | BLUE with WHITE TRACER |
| 109 | ORANGE | GREEN with WHITE TRACER |
| 110 | ORANGE | BLACK with WHITE TRACER |

STOCKPILE STANDARDS

| | | |
|---|---|---|
| 116 | YELLOW | WHITE with RED FLECK |
| 117 | YELLOW | RED with WHITE TRACER |
| 118 | YELLOW | BLUE with WHITE TRACER |
| 119 | YELLOW | GREEN with WHITE TRACER |
| 120 | YELLOW | BLACK with WHITE TRACER |

### EXEMPLARY COLOR CODES FOR CALIBRATION/REFERENCE STANDARDS

The shells 62 of a set of calibration/reference standard components 60 that are provided for use with a given material analyzer and the longitudinal extent of the standard component 60 packaged therein are longer than the dimension of the measurement region 34 in the direction in which the material specimen 38 is transported through the measurement region 34 and long enough to allow the calibration/reference standard component 60 to be positioned within the measurement region 34 of the given material analyzer without the use of any additional tools.

Since only a portion of the length of interior of the shell 62 is required for containing the standard component 60, most of the remaining interior portion of the shell 62 is filled with a sturdy, light-weight filler material 70, such as an insulating plastic foam, such as a polyurethane packaging foam, which is disposed between the standard component 60 and the end cap 66a that is color-coded. This filler material 70 compresses and positions the standard component 60 in a desired portion of the shell 62 and adds to the strength of the packaging without adding significantly to the weight of the packaging. In an alternative embodiment (not shown) filler material is disposed between the standard component 60 and the end caps 66, 66a at both ends of the shell 62.

At least one sealing disk 72 is disposed at the interface between the standard component 60 and the filler material 70. Another sealing disk 72a is disposed at the interface between the standard component 60 and the end cap 66 that is not color-coded. The sealing disks 72, 72a are made of an appropriate material, such as a closed cell foam, such as polyurethane or polystyrene, to retain the standard material in a given lateral portion of the shell 62 and to prevent an interaction between the material of the standard component 60 and other materials.

The standard component 60 is compressed by the filler material 70 and the disks 72, 72a during assembly within the shell 62 to better withstand segmentation and stratification during handling.

The shell 62, the straps 64, 64a, the end caps 66, 66a, the filler material 70 and the sealing disks 72, 72a are made of materials that minimally interfere with the measurement of the calibration/reference standard 60 by a material analyzer.

Preferably, the shell 62 is tubular and of approximately uniform lateral dimensions in at least the portion of the shell 62 that contains the standard component 60 of known chemical composition. In the preferred embodiment, this portion of the shell 62 has a circular lateral cross-section. In other embodiments, such portion of the shell 62 has a different lateral cross-section, such as polygonal. Preferably, the portion of the shell 62 having approximately uniform lateral dimensions extends to the end caps 66, 66a.

In the preferred embodiment, a set of calibration/reference standard components 60 for use with a given material analyzer includes individually packaged standard components 60 of respectively different lateral dimensions so that the set of such multi-dimensional packaged standard components 60 can be combined to better simulate the occupancy of a plurality of measurement regions of various sizes and shapes.

In the preferred embodiment, a set of calibration/reference standard components 60 for-use with a given material analyzer also includes individually packaged standard components 60 of respectively different chemical composition so that standard components 60 of different chemical compositions can be simultaneously disposed in the measurement region of a material analyzer to simulate the occupancy of the measurement region by a more diverse range specimen materials. This feature is advantageously combined with the feature of providing a set of individually packaged standard components 60 of respectively different lateral dimensions to simultaneously simulate the occupancy of a plurality of measurement regions of various sizes and shapes.

The calibration/reference standard component 60 is packaged for unaided handling by two persons, or preferably one person. Including the packaging, the weight of the standard component 60 is such that one person can easily move and manipulate the component 60, yet large enough so that even the largest material analyzer can be serviced with a relatively small number of standard components 60. The length and the lateral cross section of the shell 62 are such that the packaged standard component 60 can be conveniently handed. In a preferred embodiment, a set of calibration/reference standard components 60 includes shells 62 having a length of approximately five feet (152 cm), respectively different circular lateral diameters of three, four and six inches (76, 100 and 152 mm) and weights within a range of from approximately 10 to approximately 25 kilograms. Other embodiments have different lengths, lateral dimensions and weights. The packaged individual standard components 60 are self-supporting, durable and of reasonable size and weight they can be moved one at a time by a single person or in groups by power-operated machines, such as forklifts or cranes.

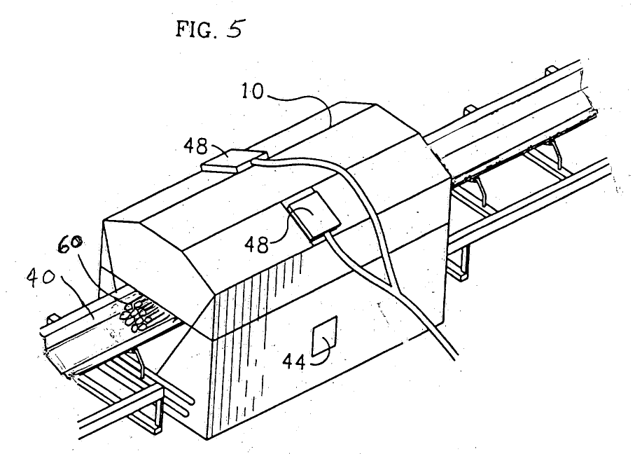

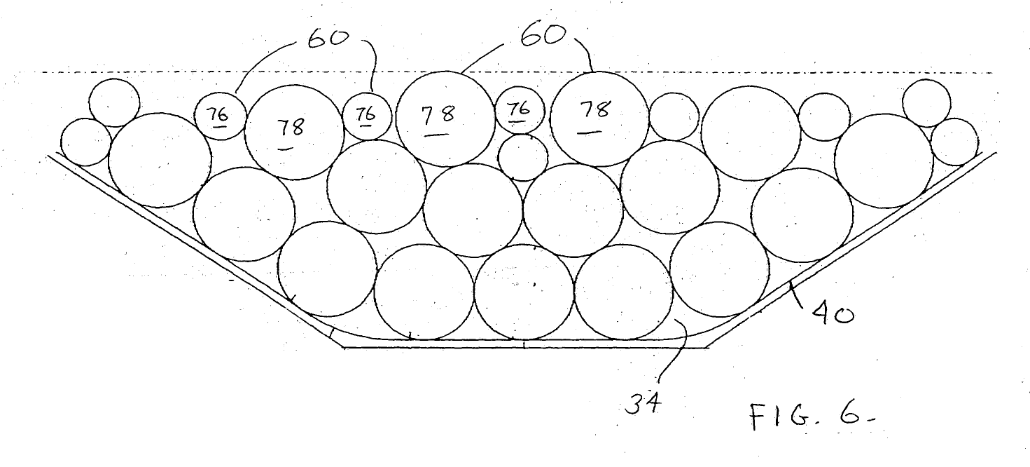

Referring to FIG. 5, during a method of calibrating and/or validating the calibration of a material analyzer, a set of elongated calibration/reference standard components 60 that are individually packaged in a hard shell 62, as described above, are so combined with each other and positioned within the measurement region 34 of the material analyzer as to simulate the occupancy within a given portion of the measurement region by a material specimen. The shells 62 of such set of standard components 60 are positioned within the measurement region so that their respective longitudinal axes are approximately aligned with the direction in which the material specimen is transported through the measurement region 34.

The individually packaged components 60 are disposed within the measurement region so that the standard components 60 of known chemical composition extend throughout the dimension of the measurement region 34 in the direction in which the material specimen is transported through the measurement region and so that the filler material 70 is not disposed within the measurement region 34.

The individual shells are disposed within the measurement region so that the respective portions of approximately uniform lateral dimensions that contain the standard components 60 of known chemical compositions are disposed within the measurement region.

The straps 64, 64a attached to the shells 62 are handled to position the individually packaged components 60 within the measurement region 34 of the analyzer.

The individual shells 60 are inserted into the measurement region 34 of the analyzer in such a manner that no part of a person handling the straps 64, 64a is disposed within the measurement region during such insertion.

The individually packaged calibration/reference standard components 60 are disposed in the measurement region of the analyzer so that the respective color codes for all of the components 60 are visible from a single location. Preferably, this is at the end of measurement region 34 at which the color-coded straps 64a attached to one end of the standard components 60 are handled.

Referring to FIG. 6, individually packaged calibration/reference standard components 60 of different lateral dimensions 76, 78 are disposed in combination with each other to simulate the occupancy of the measurement region 34 by the material specimen during the measurement of the properties of the material specimen.

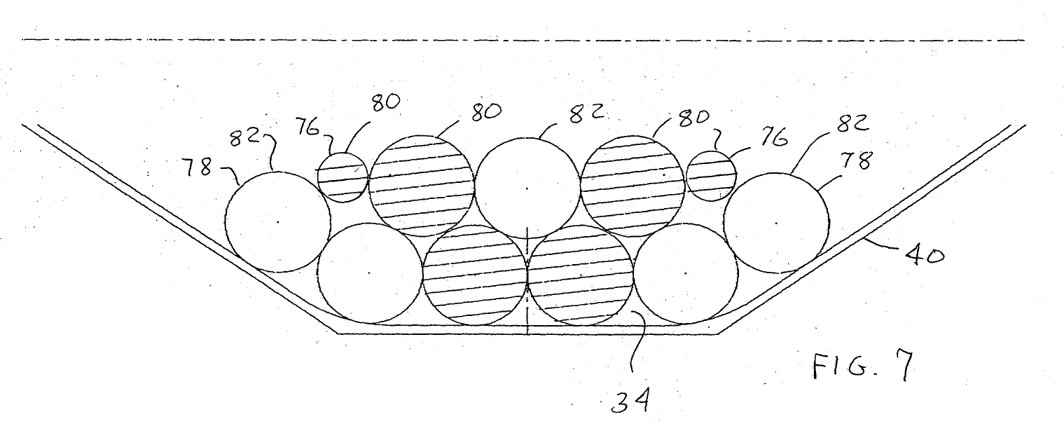

Referring to FIG. 7, individually packaged calibration/reference standard components 60 of different lateral dimensions 76, 78 and of respectively different chemical composition 80, 82 are disposed in combination with each other to simulate the occupancy of the measurement region 34 by the material specimen during the measurement of the properties of the material specimen and to simulate the chemical composition of the material specimen.

The packaged calibration/reference standard components 60 of the present invention described herein are also used in the same manner as described herein for calibrating and/or validating the calibration of a material analyzer of the type in which the material specimen is transported through the measurement region within a chute.

The present invention provides a number of benefits, including: (a) packaging of the standard materials so that they are easier to manipulate, store and position; (b) color-coding of the standard component packaging that enables the various standards to be identified and selected with greater ease and accuracy then previously possible; (c) so locating such color-coding on the component packaging such that it is visible from outside of the analyzer to thereby enable easy and positive confirmation of the standard materials being used and their physical distribution; (d) enabling standard components of different chemical compositions to be intermixed to provide a greater variety of measurements with fewer components and without danger of contamination; (e) significantly reducing the amount of time and effort required to manufacture and store the calibration/reference standard components; (f) enabling a minimum number of standard components to be stored in the factory and at a customers site, in that a single set of standard components can be used with multiple analyzers located in the same general area; (g) replacing damaged standard components is easier and cheaper than replacing the larger standard modules presently in use; (h) mass production of the standard components is possible since one size shell can be used with various sizes and shapes of conveyor system or pipelines; and (i) current customers can be provided with the service of upgrading existing standards to the new standard component configuration described herein at reasonable cost.

The benefits specifically stated herein do not necessarily apply to every conceivable embodiment of the present invention. Further, such stated benefits of the present invention are only examples and should not be construed as the only benefits of the present invention.

While the above description contains many specificities, these should not be construed as limitations on the scope of the present invention, but rather as examples of the preferred embodiments described herein. Other variations are possible and the scope of the present invention should be determined not by the embodiments described herein but rather by the claims and their legal equivalents.

1. A method of calibrating and/or validating the calibration of a material analyzer having a measurement region and measurement apparatus for measuring properties of a material specimen occupying a given portion of the measurement region while the material specimen is transported through the measurement region in a given direction, comprising the steps of:
(a) placing a calibration/reference standard of known chemical composition within the measurement region of the analyzer to simulate the occupancy of the given portion of the measurement region by the material specimen;
(b) making measurements with the measurement apparatus of the analyzer while the calibration/reference standard is within the measurement region; and
(c) calibrating or validating the calibration of the measurement apparatus in accordance with said measurements;
wherein step (a) comprises the step of:
(d) positioning within the measurement region a set of elongated calibration/reference standard components that are individually packaged in a hard shell for being so combined with each other as to simulate the occupancy within the given portion of the measurement region by the material specimen, and are further individually packaged for unaided handling of individual said components by one or,two persons with the individually packaged components being positioned within the measurement region so that their respective longitudinal axes are approximately aligned with the direction in which the material specimen is transported through the measurement region.

2. A method according to claim 1, wherein gripping means are attached to at least one end of the individual shells, and wherein step (a) further comprises the step of:
(e) handling said gripping means to position the individually packaged components within the measurement region of the analyzer.

3. A method according to claim 2, wherein the individual shells are longer than the dimension of the measurement region in the direction in which the material specimen is transported through the measurement region, and wherein step (e) further comprises the step of:
(f) individually inserting the individual shells into the measurement region of the analyzer in such a manner that no part of a person handling the gripping means is disposed within the measurement region during said insertion.

4. A method according to claim 1, wherein step (d) comprises the step of:
(e) disposing individually packaged calibration/reference standard components of different lateral dimensions in combination with each other to simulate the occupancy of the measurement region by the material specimen during the measurement of the properties of the material specimen.

5. A method according to claim 1, wherein step (d) comprises the step of:
(e) disposing individually packaged calibration/reference standard components of respectively different chemical composition in combination with each other to simulate the chemical composition of the material specimen.

6. A method according to claim 1, wherein step (d) comprises the step of:
(e) disposing individually packaged calibration/reference standard components of different lateral dimensions and of respectively different chemical composition in combination with each other to simulate the occupancy of the measurement region by the material specimen during the measurement of the properties of the material specimen and to simulate the chemical composition of the material specimen.

7. A method according to claim 1, wherein at least one end of the packaging of each of the calibration/reference standard components displays a color code indicating the chemical composition of the respective calibration/reference standard component, and wherein step (d) comprises the step of:
(e) disposing the individually packaged components so that the respective color codes for all of the components are visible from a single location.

8. A method according to claim 1, wherein common exterior locations on the packages of the calibration/reference standard components respectively display color-codes indicating the chemical composition of the respective calibration/reference standard components, and wherein step (d) comprises the step of:
(e) disposing the individually packaged components so that the respective color codes for all of the components are visible from a single location.

9. A method according to claim 1, wherein the individual shells and the longitudinal extent of the standard component of said known chemical composition packaged therein are longer than a given dimension of the measurement region in the direction in which the material specimen is transported through the measurement region, and wherein the individual shells include a filler material disposed between the standard component of known chemical composition and at lest one end of the shell, and wherein step (d) comprises the step of:
(e) disposing the individually packaged components within the measurement region so that the standard components of known chemical composition extend throughout the given dimension of the measurement region and so that the filler material is not disposed within the measurement region.

10. A method according to claim 1, wherein the individual shells are tubular and of approximately uniform lateral dimensions in a portion of the shell that contains the standard component of said known chemical composition; and wherein step (d) comprises the step of:
(e) disposing the individual shells within the measurement region so that the respective portions of approximately uniform lateral dimensions are disposed within the measurement region.

11. A method according to claim 1, wherein the individually packaged calibration/reference standard components are packaged for unaided handling by one person.

12. A calibration/reference standard component of known chemical composition for use in calibrating and/or validating the calibration of a material analyzer of the type that has a measurement region and measurement apparatus for measuring properties of a material specimen occupying a given portion of the measurement region, and which is calibrated or the calibration is validated by taking measurements while a calibration/reference standard of known chemical composition is disposed within the measurement region of the analyzer to simulate the occupancy of the given portion of the measurement region by the material specimen,
wherein the component is packaged in an elongated hard shell for being so combined with other said components in said measurement region as to simulate the occupancy within the given portion of the measurement region of the material specimen; and
wherein the component is packaged for unaided handling by one or two persons.

13. A calibration/reference standard component according to claim 12, wherein the packaging includes gripping means attached to at least one end of the shell for use in handling the shell.

14. A calibration/reference standard component according to claim 12, wherein at least one end of the packaging displays a color code indicating the chemical composition of the calibration/reference standard component.

15. A calibration/reference standard component according to claim 12, wherein an exterior location on the packaging displays a color code indicating the chemical composition of the calibration/reference standard component.

16. A calibration/reference standard component according to claim 12, wherein the shell includes a filler material disposed between the standard component of said known chemical composition and at lest one end of the shell.

17. A calibration/reference standard component according to claim 12, wherein the shell is tubular and of approximately uniform lateral dimensions in a portion of the shell that contains the standard component of said known chemical composition.

18. A calibration/reference standard component according to claim 12, wherein the component is packaged for unaided handling by one person.

19. A set of calibration/reference standard components for use in calibrating and/or validating the calibration of a material analyzer of the type that has a measurement region and measurement apparatus for measuring properties of a material specimen occupying a given portion of the measurement region, and which is calibrated or the calibration is validated by taking measurements while a calibration/reference standard of known chemical composition is disposed within the measurement region of the analyzer to simulate the occupancy of the given portion of the measurement region by the material specimen, the set comprising:
elongated calibration/reference standard components that are individually packaged in a hard shell for being so combined with each other in said measurement region as to simulate the occupancy within the given portion of the measurement region of the material specimen, and are further individually packaged for unaided handling of individual said components by one or two persons.

20. A set of calibration/reference standard components according to claim 19, comprising gripping means attached to at least one end of the individual shells for use in handling each of the individual shells.

21. A set of calibration/reference standard components according to claim 14 in combination with a material analyzer that has a measurement region of a given dimension in a direction in which the material specimen is transported through the measurement region during measurement of the properties of the material specimen,
wherein the individual shells are longer than the given dimension of the measurement region in the direction in which the material specimen is transported through the measurement region so that gripping means attached to at least one end of the individual shells can be disposed outside the measurement region when the individual shells are disposed within the measurement region with their respective longitudinal axes approximately aligned with said given direction.

22. A set of calibration/reference standard components according to claim 19, wherein some of the individually packaged calibration/reference standard components have a different lateral dimension than some of the other the individually packaged calibration/reference standard components.

23. A set of calibration/reference standard components according to claim 19, wherein some of the individually packaged calibration/reference standard components have a different lateral dimension and a different chemical composition than some of the other individually packaged calibration/reference standard components.

24. A set of calibration/reference standard components according to claim 19, wherein some of the individually packaged calibration/reference standard components have a different chemical composition than some of the other individually packaged calibration/reference standard components.

25. A set of calibration/reference standard components according to claim 19, wherein at least one end of the packaging of each of the calibration/reference standard components displays a color code indicating the chemical composition of the respective calibration/reference standard component.

26. A set of calibration/reference standard components according to claim 19, wherein a common exterior location on the packaging of the calibration/reference standard components displays color codes indicating the chemical composition of the respective calibration/reference standard components.

27. A set of calibration/reference standard components according to claim 19, wherein the individual shells include a filler material disposed between the standard component of said known chemical composition and at lest one end of the shell.

28. A set of calibration/reference standard components according to claim 19, wherein the individual shells are tubular and of approximately uniform lateral dimensions in a portion of the shell that contains the standard component of said known chemical composition.

29. A set of calibration/reference standard components according to claim 19, wherein the individually packaged calibration/reference standard components are packaged for unaided handling by one person.
